(19) United States
(12) Patent Application Publication
(10) Pub. No.: US 2024/0233773 A1
(43) Pub. Date: Jul. 11, 2024

(54) ELECTRONIC DEVICE AND CONTENT EDITING METHOD OF ELECTRONIC DEVICE

(71) Applicant: SAMSUNG ELECTRONICS CO., LTD., Suwon-si (KR)

(72) Inventors: Kyunghwa SEO, Suwon-si (KR); Seonho KIM, Suwon-si (KR); Yeongjune CHOI, Suwon-si (KR)

(21) Appl. No.: 18/613,977

(22) Filed: Mar. 22, 2024

Related U.S. Application Data
(63) Continuation of application No. PCT/KR2022/012447, filed on Aug. 19, 2022.

(30) Foreign Application Priority Data
Sep. 24, 2021 (KR) 10-2021-0126384
Nov. 4, 2021 (KR) 10-2021-0150794

(51) Int. Cl. G11B 27/031; G06F 3/04817

(52) U.S. Cl. CPC G11B 27/031; G06F 3/04817

(57) ABSTRACT

An electronic device according to various embodiments includes: a display; a memory; and a processor. The processor is configured to execute instructions to perform operations including: display a preview of media content in a first area of the display, display at least one frame corresponding to the media content in a second area of the display, select at least one object contained within the first area, determine a frame segment corresponding to the object in response to the selection, and display the frame segment visually distinct from other segments.

### CROSS-REFERENCE TO RELATED APPLICATIONS

This application is a continuation application under, 35 U. S.C. § 111(a), of International Application No. PCT/KR2022/012447 designating the United States, filed on Aug. 19, 2022, in the Korean Intellectual Property Receiving Office and claiming priority to Korean Patent Application No. 10-2021-0126384, filed on Sep. 24, 2021 in the Korean Intellectual Property Office and Korean Patent Application No. 10-2021-0150794, filed on Nov. 4, 2021 in the Korean Intellectual Property Office, the disclosures of which are incorporated by reference herein in their entireties.

### BACKGROUND

The disclosure relates to an electronic device and a method for editing media content.

With the growth of mobile communication technology and processor technology, portable electronic devices (hereinafter referred to as electronic devices) have been able to implement various functions beyond a traditional communication function. For example, an electronic device can display or reproduce images, videos, and text files on a display.

The electronic device can provide at least one graphic object on the display while reproducing video data, and change settings for the video data based on a user input for the graphic object.

The electronic device can frequently switch a display method of an area required for editing content in response to a user input and can generate various content based on a user input.

When editing various contents in the electronic device, the user may desire an intuitive editing method for usability. In particular, various objects can be inserted when media content is edited, and the electronic device can separately display a timeline of the media content and a timeline of the inserted object. In this case, the number of objects that can be inserted may be limited due to limitations in a space for displaying the timelines on the display.

Alternatively, the electronic device may display a timeline related to the inserted object based on a user input for editing the object only when there is the user input. In this case, it may be difficult for the user to intuitively know the location of the inserted object, so the user may experience inconvenience of having to randomly move the content timeline to find the location of the inserted object. Additionally, the user who desires to edit a specific object may have to randomly move the content timeline (or playback point) to find when the specific object was inserted on the content. For such reasons, the user may feel uncomfortable during the content editing process.

### SUMMARY

According to various embodiments of the disclosure, an electronic device includes a display, a memory, and a processor. The processor is configured to display a preview of media content in a first area of the display, display at least one frame corresponding to the media content in a second area of the display, select at least one object contained within the first area, determine a frame segment corresponding to the object in response to the selection, and display the frame segment visually distinct from other segments.

According to various embodiments of the disclosure, a content editing method of an electronic device includes displaying at least some frames of media content in a first area of a display, based on a playback time of the media content; displaying at least one section indicating at least one object included in the media content near the first area of the display, based on at least one object information corresponding to the at least one object; and displaying at least one user interface corresponding to the at least one section determined based on a user input on the at least one object in at least a portion of the first area.

Various embodiments of the disclosure can provide an electronic device and a content creation method thereof, which can allow users to easily view and edit content.

Various embodiments of the disclosure can intuitively provide information about an inserted object to users without inconvenience of having to randomly move the timeline of content to find the location of the inserted object.

Various embodiments of the disclosure can organize the timeline of an inserted object into one rather than displaying it separately, thereby preventing the number of insertable objects from being limited due to limitations in a space for displaying the timeline, and intuitively providing information about the inserted object to users.

### BRIEF DESCRIPTION OF DRAWINGS

The above and other exemplary embodiments, advantages and features of this disclosure will become more apparent by describing in further detail exemplary embodiments thereof with reference to the accompanying drawings, in which:

FIG. 1 is a block diagram of an electronic device in a network environment according to various embodiments.

FIG. 2 is a block diagram of an electronic device according to various embodiments.

FIG. 3 illustrates a content editing process of an electronic device according to a

comparative example and a content editing process of an electronic device according to various embodiments.

FIG. 4 illustrates a content editing situation of an electronic device according to various

embodiments.

FIG. 5 illustrates a situation where a plurality of objects are edited on content of an electronic device according to various embodiments.

FIG. 6A illustrates a situation where an object insertion section on content is edited in an electronic device according to various embodiments.

FIG. 6B illustrates a situation where an object is newly inserted in an electronic device according to various embodiments.

FIG. 6C illustrates a situation where an object is deleted in an electronic device according to various embodiments.

FIG. 7A illustrates a situation where a plurality of objects are selected together and edited simultaneously in an electronic device according to various embodiments.

FIG. 7B illustrates a situation where an editing function for a specific object is locked in an electronic device according to various embodiments.

FIG. 7C illustrates a situation where a link function of a plurality of objects is activated in an electronic device according to various embodiments.

FIG. 8 illustrates a method for editing content in an electronic device according to various embodiments.

### DETAILED DESCRIPTION

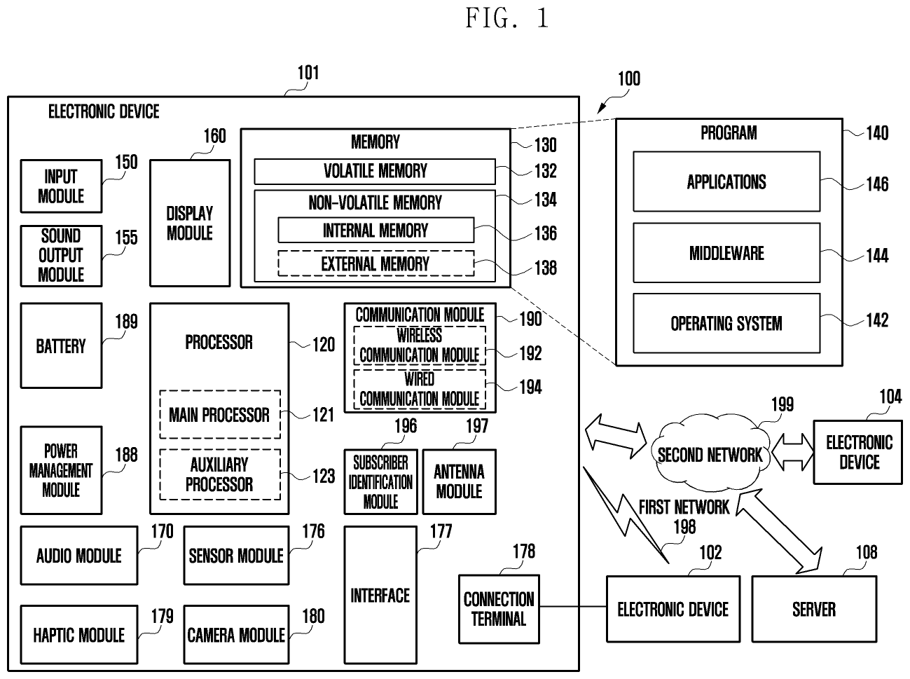

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

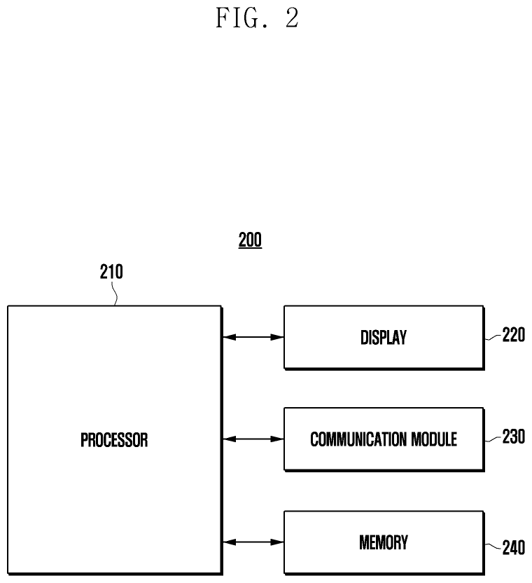

FIG. 2 is a block diagram of an electronic device according to various embodiments.

With reference to FIG. 2, the electronic device 200 may include a display 220, a communication module 230, a processor 210, and a memory 240. In various embodiments, some of the illustrated components may be omitted or replaced. The electronic device 200 may further include at least some of the components and/or functions of the electronic device 101 in FIG. 1. At least some of the components of the electronic device 200 shown (or not shown) may be operatively, functionally, and/or electrically connected.

According to various embodiments, the display 220 may display various images under the control of the processor 210. The display 220 may be implemented, but is not limited to, as any one of a liquid crystal display (LCD), a light-emitting diode (LED) display, or an organic light-emitting diode (OLED) display. The display 220 may be formed as a touch screen that detects a touch and/or proximity touch (or hovering) input using a user's body part (e.g., finger) or an input device (e.g., stylus pen). The display 220 may include at least part of the configuration and/or function of the display module 160 in FIG. 1.

According to various embodiments, the display 220 may be flexible at least in part and may be implemented as a foldable display or a rollable display.

According to various embodiments, the communication module 230 may communicate with an external device through a wireless network under the control of the processor 210. The communication module 230 may include hardware and software modules for transmitting/receiving data to/from a cellular network (e.g., long term evolution (LTE) network, 5G network, new radio (NR) network) and a short-distance network (e.g., Wi-Fi, Bluetooth). The communication module 230 may include at least part of the configuration and/or function of the communication module 190 in FIG. 1.

According to various embodiments, the memory 240 may include a volatile memory (e.g., the volatile memory 132 in FIG. 1) and a non-volatile memory (e.g., the non-volatile memory 134 in FIG. 1) and may store data temporarily or permanently. The memory 240 may include at least part of the configuration and/or function of the memory 130 in FIG. 1 and may store the program 140 in FIG. 1.

According to various embodiments, the memory 240 may store various instructions that can be executed by the processor 210. These instructions may include control instructions such as arithmetic and logical operations, data transfer, input/output, etc. that can be recognized by the processor 210.

According to various embodiments, the processor 210 is operatively, functionally, and/or electrically connected to the respective components of the electronic device 200 (e.g., the display 220, the communication module 230, the memory 240) and may perform operations or data processing related to control and/or communication of each component. The processor 210 may include at least part of the configuration and/or function of the processor 120 in FIG. 1.

According to various embodiments, there will be no particular limitations on the operation and data processing functions that the processor 210 can implement in the electronic device 200. However, described hereinafter are various embodiments for displaying a user interface that can display an object-inserted section through analysis of information about an object inserted on media content (hereinafter referred to as content) and can allow object information to be edited based on a user input on the object. The operations of the processor 210, which will be described later, may be performed by loading instructions stored in the memory 240.

According to various embodiments, the electronic device 200 may include the display 220, the memory 240 that stores information about at least one object, and the processor 210. The processor 210 may display at least some frames of media content in a first area based on a playback time of the media content, display at least one section corresponding to at least one object based on at least one object information included in the media content, determine at least one section corresponding to at least one object based on a user input on the at least one object, and display at least one user interface corresponding to the determined at least one section in at least a portion of the first area.

According to an embodiment, the at least one section corresponding to the at least one object may include the form of a relatively thin line compared to the first area, and it may be displayed at a location corresponding to the first area in time based on a time zone when the corresponding at least one object is inserted into the media content. The first area may refer to a timeline containing frame display information of the content, and it may be displayed in the form of a bar. However, the form of the first area is not limited thereto, and it may include any form that can represent the frame display information of the content. Additionally, the first area may be displayed at any location on the display and may not necessarily be limited to the bottom area of the content.

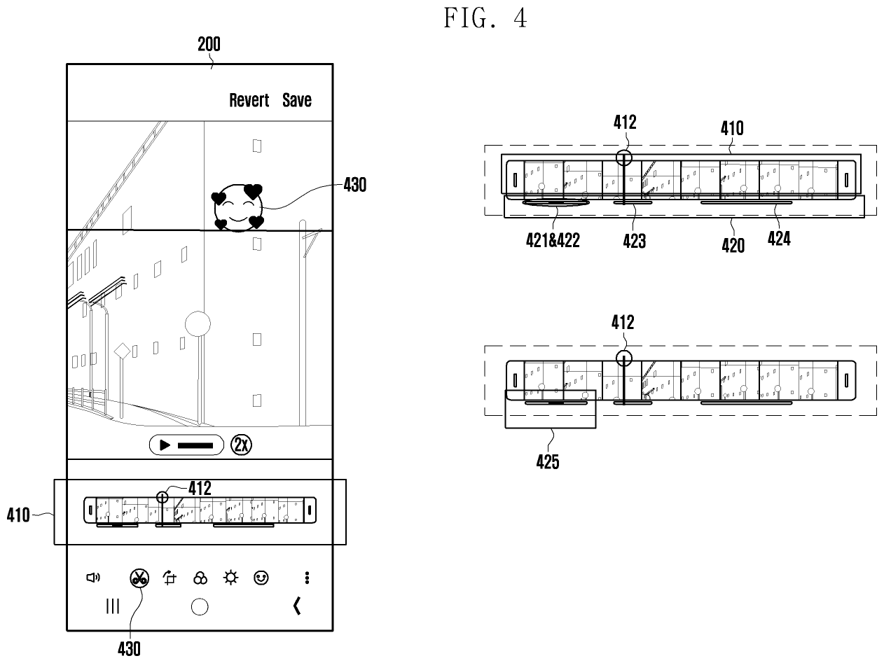

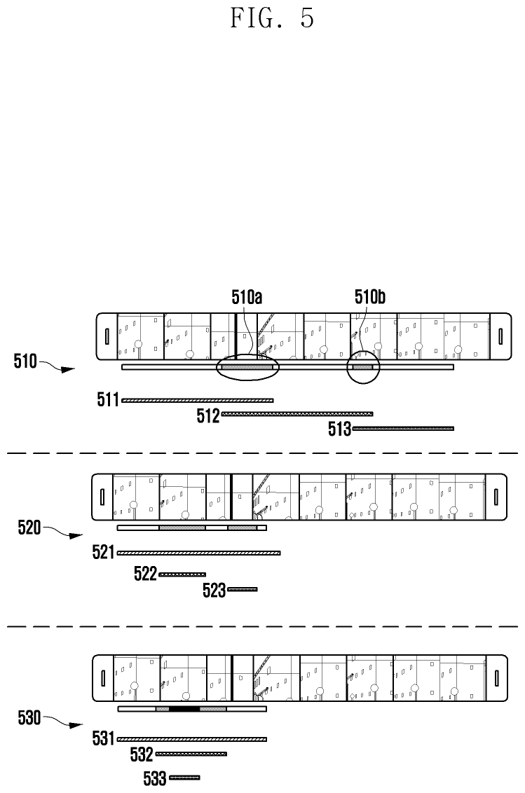

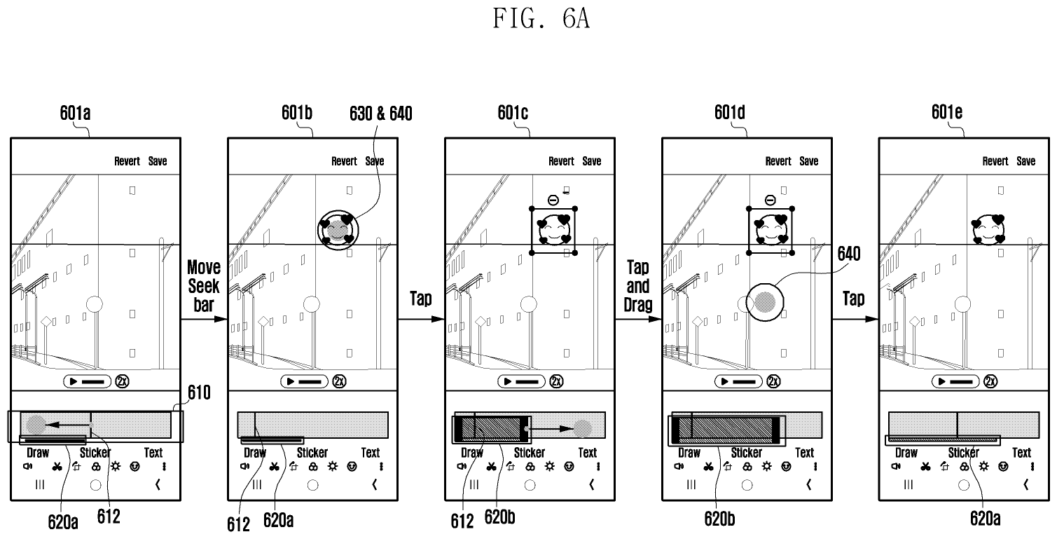

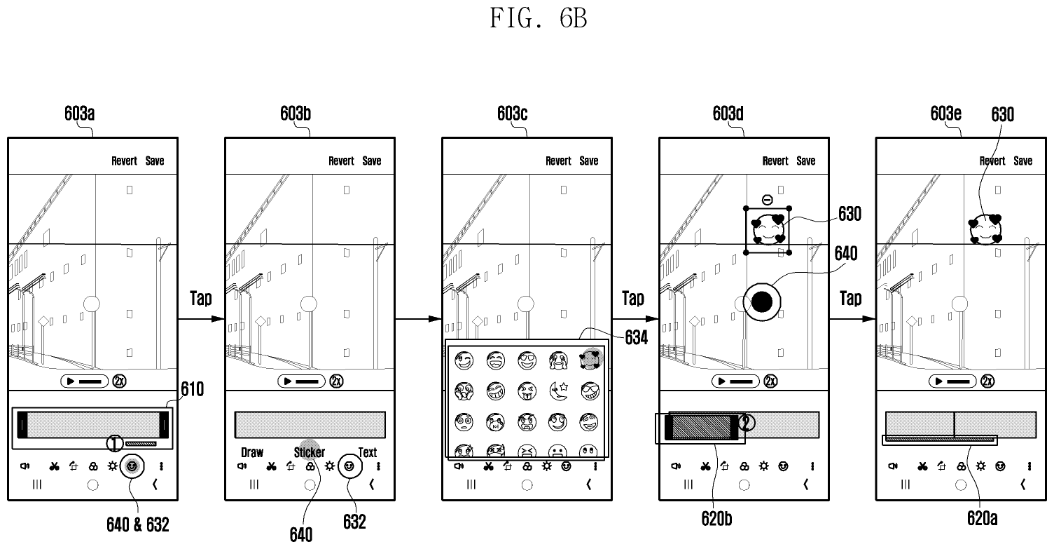

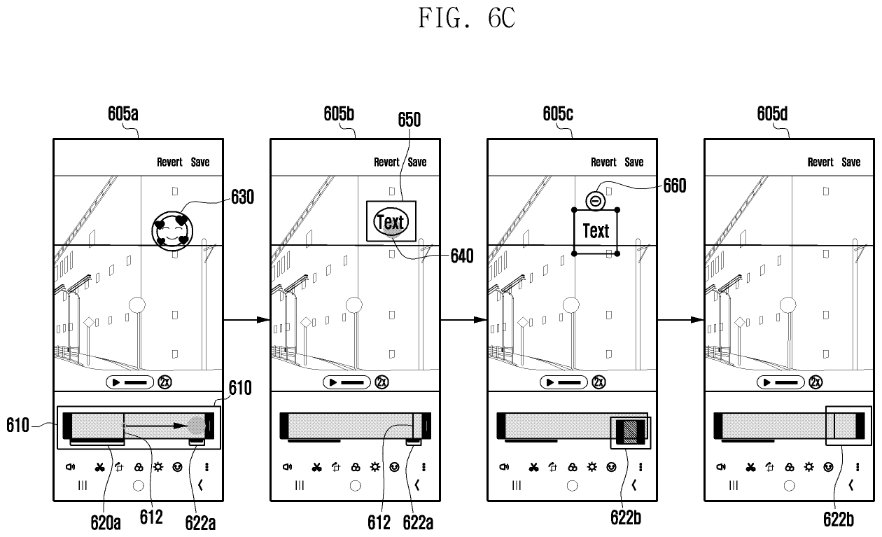

According to an embodiment, the at least one user interface may be displayed in the first area, and it may be displayed at a location corresponding to the first area in time based on a time zone when the corresponding at least one object is inserted into the media content. The forms and roles of at least one object and at least one section will be described in detail in FIGS. 4 and 5, and the at least one user interface will be described in detail in FIGS. 6A to 6C.

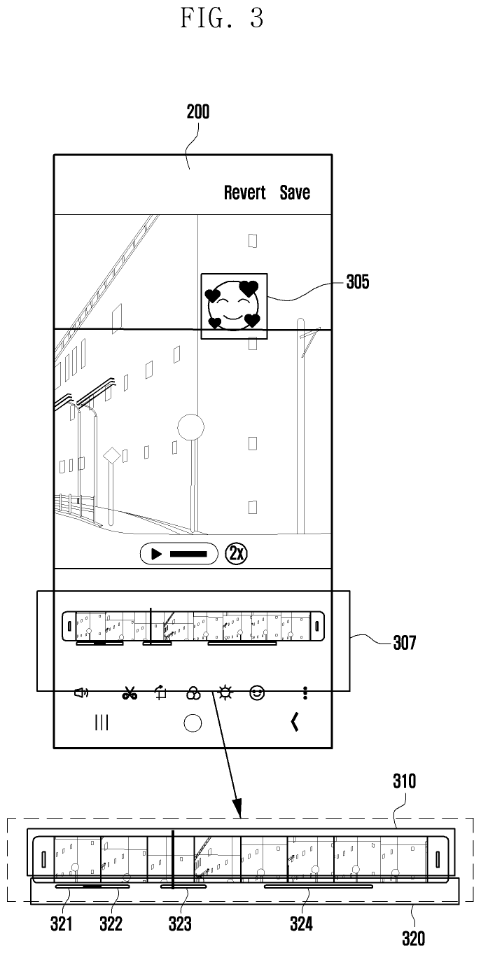

FIG. 3 illustrates a content editing process of an electronic device according to various embodiments.

The electronic device 200 according to various embodiments may execute and edit media content including video on a gallery. The electronic device 200 may display at least one object 305 on content based on information about the at least one object 305 included in the content. The object 305 may include at least one form of an emoticon, a sticker, a text, or a drawing, but it may not be limited thereto. The drawing may include not only a figure or an image but also an input using at least one of a user's body or a stylus pen. In addition, the at least one object information may include at least one of the type of the at least one object, the display position (coordinates) of the at least one object, the size of the at least one object, the display direction of the at least one object, the time when the at least one object is inserted in the content, whether the at least one object is deleted, or link information connected to the at least one object, but it may not be limited thereto.

The electronic device according to a comparative example may display at least some frames of content in a first area based on a playback time of the content. As previously mentioned, the first area may have the form of a timeline bar, but it is not limited thereto. When the object 305 is inserted, the electronic device according to the comparative example may create a new second area (e.g., timeline) corresponding to the inserted object and display the second area together with the first area on the display. Alternatively, the electronic device may temporarily display a timeline separate from the first area only when a user input is applied on the inserted object 305. In this case, space limitations may occur because the display has to always display a separate timeline in an area other than the first area. That is, the electronic device according to the comparative example may be controlled to insert only a limited number of objects into the content due to limitations in display space.

The electronic device 200 and the content editing method of the electronic device 200 according to various embodiments of the disclosure can overcome the above-mentioned inconvenience in the content editing process and provide a convenient user experience.

An area indicated by 307 shows a content editing situation of the electronic device 200 according to various embodiments of the disclosure. Areas indicated by 310 and 320 correspond to enlargement of the area indicated by 307. The electronic device 200 according to the disclosure may display, on the display 220, a first area 310 that displays at least some frames of media content based on the playback time of the media content. In addition, based on information about at least one object included in the media content, the electronic device 200 may display a second area 320 near or on the first area 310. The second area 320 may include at least one region (e.g., 321 to 324) corresponding to the at least one object 305.

According to an embodiment, the at least one region 321 to 324 displayed in the second area 320 may have, but is not limited to, a bar shape that is relatively thinner than the first area 310. In addition, the at least one region 321 to 324 displayed in the second area 320 is not limited to an image form, and it may have any form that can represent information about the at least one object included in the media content to the user. Hereinafter, the at least one region 321 to 324 displayed in the second area 320 will be referred to as a first section 321 to a fourth section 324.

The first area 310 may refer to an area that contains at least some frames of media content when the media content is reproduced on the display 220. The second area 320 may refer to an area that indicates an insertion position of at least one object 305 when the at least one object 305 is inserted. The second area 320 may be located on or near the first area 310. In addition, the second area 320 may have a relatively thin size compared to the first area 310. Hereinafter, in FIG. 4, the first area 310 and the second area 320 will be described in detail.

FIG. 4 illustrates a content editing situation of an electronic device according to various embodiments.

According to various embodiments, an electronic device (e.g., the electronic device 200 in FIG. 2) may include a display (e.g., the display 220 in FIG. 2), a memory (e.g., the memory 240 in FIG. 2) that stores information about at least one object, and a processor (e.g., the processor 210 in FIG. 2). The processor 210 may display at least some frames of media content in a first area 410 based on a playback time of the media content, display a first section 421 corresponding to at least one object based on information about the at least one object included in the media content, and determine the first section 421 corresponding to the at least one object based on a user input on the at least one object. The frames displayed in the first area 410 may include frames associated with the media content currently displayed on the display 220. For example, the leftmost frame among the frames displayed in the first area 410 may indicate the start point of the media content displayed on the display 220. Alternatively, the rightmost frame among the frames displayed in the first area 410 may indicate the end point of the media content displayed on the display 220.

According to an embodiment, at least one section 421 to 424 corresponding to the at least one object may have the form of a relatively thin line compared to the first area 410, and it may be displayed at a location corresponding to the first area 410 in time based on a time zone when the corresponding at least one object is inserted into the media content. The first area 410 may refer to a timeline containing frame display information of the content, and it may be displayed in the form of a bar. However, the form of the first area 410 is not limited to this, and it may have any form that can represent the frame display information of the content. Additionally, the first area 410 may be displayed at any location on the display and not necessarily be limited to the bottom area of the content.

According to an embodiment, the first area 410 may contain the frame display information of the content. The length of the first area 410 may be determined to correspond to the playback time of the content. The processor 210 may determine a frame to be displayed on the display (e.g., the display 220 in FIG. 2) based on the position of an indicator 412 in the first area 410. The processor 210 may display at least one section corresponding to at least one inserted object in the second area 420 based on information about objects inserted in the content. For example, in the case where a total of four objects (i.e., a first object, a second object, a third object, and a fourth object) are inserted in the content of the electronic device 200, the electronic device may display a total of four sections or regions (i.e., a first section 421, a second section 422, a third section 423, and a fourth section 424) corresponding to the objects in the second area. Although FIG. 4 shows for example that a total of four objects are inserted, the number of objects that can be inserted in the content is not limited to this example.

The second area 420 and at least one section corresponding to an object in the second area may be displayed near the first area 410 based on object information, and they may be displayed at a location corresponding to the first area 410 in time. For example, the first section 421 corresponding to an object that appears initially in the content may be displayed at a position corresponding to a left portion of the first area 410, and the fourth section 424 corresponding to an object that appears later in the content may be displayed at a position corresponding to a right portion of the first area 410. In addition, the electronic device 200 may display a particular image at a position corresponding to or adjacent to the frame containing the object 430 on the frames displayed in the first area 410. This particular image may have, but is not limited to, the form of a line. From this image, the user can know where the object 430 is inserted in the frame displayed in the first area 410. As the time for which the object is displayed on the content increases, the length of at least one corresponding section 421 to 424 may also increase. Conversely, as the time for which the object is displayed on the content decreases, the length of at least one corresponding section 421 to 424 may also be reduced. Using the at least one section 421 to 424 displayed, the user can identify at least one of the inserted position of the object 430 or the length of the inserted time of the object 430 without directly playing the content or moving the timeline.

According to an embodiment, when the number of objects inserted in content in the electronic device 200 is two, at least one object may be referred to as, for example, a first object and a second object. The number of objects that can be displayed on the electronic device 200 may not be limited to this. At least one section may include the first section 421 corresponding to the first object and the second section 422 corresponding to the second object. The first section 421 may be displayed at a location corresponding to the first area in time based on the time zone when the first object is inserted in the media content, and the second section 422 may be displayed at a location corresponding to the first area 410 in time based on the time zone when the second object is inserted in the media content. For example, the processor 210 may control the first section 421 and the second section 422 to be displayed below the frame in the first area 410. Also, the processor 210 may control the first section 421 and the second section 422 to be displayed not only below the frame in the first area 410 but also above the frame or adjacent to the frame within a certain distance. The position where the first section 421 and the second section 422 are displayed by the processor 210 is not limited to this, and any position where they are displayed together with the first area 410 to provide information about at least one object to the user may be possible. When the first section 421 and the second section 422 overlap with each other, the processor 210 may display at least one of color, transparency, size, shape, brightness, or saturation differently.

Area 425 shows a situation in which the first section 421 and the second section 422 are displayed to overlap in part. The electronic device according to a comparative example may use a plurality of timelines to indicate a situation where a plurality of objects are inserted. On the other hand, the electronic device 200 according to the disclosure can use a single line or region to indicate a situation where a plurality of objects are inserted. Additionally, in the case where a plurality of objects are displayed to overlap with each other on the content, the processor 210 may display at least one of color, transparency, size, shape, brightness, or saturation differently as shown in area 425 to provide information about the plurality of objects to the user. Next, in FIG. 5, a content editing method of the electronic device 200 to effectively display a situation where a plurality of objects are inserted will be described.

FIG. 5 illustrates a situation where a plurality of objects are edited on content of an electronic device according to various embodiments.

According to an embodiment, an electronic device (e.g., the electronic device 200 in FIG. 2) may include a first object (not shown), a first section 511 corresponding to the first object, a second object (not shown), a second section 512 corresponding to the second object, a third object (not shown), and a third section 513 corresponding to the third object. The number of objects and sections corresponding to the objects may not be limited to this. The object may have at least one form of an emoticon, a sticker, a text, or a drawing, but it may not be limited thereto. The drawing may include not only a figure or an image but also an input using at least one of a user's body or a stylus pen. Each of the first section 511, the second section 512, and the third section 513 may have the form of a relatively thin line compared to the first area (e.g., the first area 410 in FIG. 4), and it may be displayed at a location corresponding to the first area (e.g., the first area 410 in FIG. 4) in time based on the time zone in which the at least one corresponding object is inserted in the media content. The first area 410 may refer to a timeline containing frame display information of the content, and it may be displayed in the form of a bar, for example.

According to an embodiment, a processor (e.g., the processor 210 in FIG. 2) may determine the color of at least one section (e.g., the first section 511) corresponding to at least one object based on the type of the at least one object. For example, if the inserted object has the form of an emoticon, the processor 210 may display the corresponding section (e.g., the first section 511) in blue. Also, if the inserted object has the form of text, the processor 210 may display the corresponding section (e.g., the first section 511) in yellow. Therefore, the user can intuitively identify what type of object has been input just by looking at the color of at least one section (e.g., the first section 511) displayed near the first area 410. The type of the inserted object and the color of the corresponding section (e.g., the first section 511) are not limited to the above examples and may vary depending on the user's settings.

Example 510 shows a situation where the first, second, and third objects inserted in the content are displayed to overlap in part. Area 510a shows a situation where the first section 511 overlaps with the second section 512 in the second area 420.

According to an embodiment, when the first section 511 and the second section 512 overlap with each other, the processor 210 may display at least one of color, transparency, size, shape, brightness, or saturation differently. For example, the processor 210 may control an overlap part between the first section 511 and the second section 512 to be displayed with lower transparency or higher saturation. In addition, the processor 210 may control an overlap part among the first section 531, the second section 532, and the third section 533 to be displayed with further lower transparency or higher saturation than an overlap part between two sections. Also, the processor 210 may control an overlap part between the first and second sections 511 and 512 to be displayed to have a larger size than a non-overlap part, and control an overlap part among the first, second and third sections 511, 512 and 513 to be displayed to have a larger size than an overlap part between two sections. A method for the processor 210 to display an overlap part of a plurality of sections is not limited to the above description, and any method that can display the overlap part of the sections differentiated from non-overlap parts.

Area 510b shows a situation where the second section 512 overlaps with the third section 513 in the second area 420. According to an embodiment, when the second section 512 and the third section 513 overlap with each other, the processor 210 may display at least one of color, transparency, size, shape, brightness, or saturation differently. From areas 510a and/or 510b, the user can intuitively know a section where objects are displayed to overlap in the second area 420 and the length of the section.

Example 520 shows a situation where the first object, second object, and third object inserted in the content are all displayed to overlap. Example 520 shows that, while the first object is inserted in and displayed on the content, the second object is inserted and displayed and then disappears and thereafter the third object is inserted and displayed and then disappears. From example 520, the user can intuitively understand a section where objects are displayed to overlap in the second area 420 and the length of the section.

Example 530 shows a situation where three objects are inserted to overlap on the content. Example 530 shows that, while the first object is inserted in the content and displayed, the second object and the third object are sequentially inserted in the content and displayed, and thereafter in reverse order, the third object disappears from the content, then the second object disappears from the content, and then the first object disappears from the content. From example 530, the user can intuitively understand a section where objects are displayed to overlap in the second area 420 and the length of the section.

FIG. 6A illustrates a situation where an object insertion section on content is edited in an electronic device according to various embodiments.

According to various embodiments, an electronic device (e.g., the electronic device 200 in FIG. 2) may include a display (e.g., the display 220 in FIG. 2), a memory (e.g., the memory 240 in FIG. 2) that stores information about at least one object, and a processor (e.g., the processor 210 in FIG. 2).

According to an embodiment, at least one section 620a corresponding to at least one object 630 may have the form of a relatively thin line compared to a first area 610, and it may be displayed at a location corresponding to the first area 610 in time based on a time zone when the corresponding at least one object 630 is inserted into the media content. For example, the processor 210 may control the at least one section 620a to be displayed below the frame in the first area 610. The processor 210 may control the at least one section 620a to be displayed not only below the frame in the first area 610 but also above the frame or adjacent to the frame within a certain distance. The position where the at least one section 620a is displayed by the processor 210 is not limited to this, and any position where it is displayed together with the first area 610 to provide information about at least one object to the user may be possible. The first area 610 may refer to a timeline containing frame display information of the content, and it may be displayed in the form of a bar. However, the form of the first area 610 is not limited to this, and it may have any form that can represent the frame display information of the content. Additionally, the first area 610 may be displayed at any location on the display and not necessarily be limited to the bottom area of the content.

According to an embodiment, at least one user interface 620b may be displayed in the first area 610, and it may be displayed at a location corresponding to the first area 610 in time based on the time zone when the corresponding at least one object 630 is inserted in the media content.

In example 601a, the electronic device 200 may move an indicator bar 612 (also referred to as indicator 612) in the first area 610 based on a user input for the indicator bar 612 in the first area 610. The electronic device 200 may determine the playback time of content based on the location of the indicator bar 612.

In example 601b, the electronic device 200 may move the indicator bar 612 to the left based on a user input. Then, the indicator bar 612 may be placed within the first section 620a corresponding to the first object 630. The first section 620a may be displayed at a location corresponding to the first area 610 in time. In this case, the electronic device 200 may display the first object 630 on a display (e.g., the display 220 in FIG. 2) and recognize a user input 640 on the first object 630.

In example 601c, upon recognizing the user input 640 on the first object 630, the electronic device 200 may display a first user interface 620b corresponding to the first section 620a in at least a portion of the first area 610 based on the user input 640. The electronic device 200 may display the first user interface 620b in either a section where the first object 630 is inserted in the content or a section in which the first section 620a corresponds in time to the first area 610. The electronic device 200 may recognize a user input on the first user interface 620b.

Upon recognizing the user input on the first user interface 620b, in example 601d, the electronic device 200 may change a region where the first user interface 620b is displayed, based on the recognized user input. For example, based on a user's drag input on the right end of the first user interface 620b, the electronic device 200 may expand the first user interface 620b to the right. Thereafter, upon recognizing a user input 640 on an area other than the first object 630 and the first area 610, the electronic device 200 may terminate at least one of the editing process of the first object 630 or the editing process of the content.

Example 601e shows a situation where the electronic device 200 recognizes the user input 640 in an area excluding the first object 630 and the first area 610 and terminates the editing process of the first object 630. That is, the electronic device 200 may control the first section 620a to expand to the right as shown in example 601e, unlike the first section 620a shown in example 601a. The electronic device 200 may control the display time of the first object 630 based on at least one of the length, size, or shape of the first section 620a. For example, in the case of example 601e, the length of the first section 620a is extended to the right, so that the electronic device 200 can display the first object 630 on the content for a longer period of time than in the case of example 601a.

FIG. 6B illustrates a situation where an object is newly inserted in an electronic device according to various embodiments.

In example 603a, the electronic device 200 may detect a user input 640 on an object insertion icon 632 in a process of inserting at least one object. Then, in example 603b, the electronic device 200 may provide a guide on what type of object to be inserted, based on the user input 640 on the icon 632. According to an embodiment, the at least one object may have at least one form of an emoticon, a sticker, a text, or a drawing, but it may not be limited thereto. The drawing may include not only a figure or an image but also an input using at least one of a user's body or a stylus pen. Example 603b shows an example where the electronic device 200 provides a guide including a drawing, a sticker, and a text, but the types of objects the electronic device 200 can provide are not limited to this example. In example 603b, the electronic device 200 may recognize a user input 640 on the sticker.

Upon recognizing the user input 640 on the sticker, in example 603c, the electronic device 200 may provide a list 634 of stickers based on the user input 640. The sticker list 634 may contain a plurality of emoticons. In response to a user's settings, the electronic device 200 may change the order of provided emoticons and also change the types of provided emoticons. For example, the electronic device 200 may download a new emoticon based on a user input and provide it on the list 634. The electronic device 200 may recognize a user input on the sticker list 634.

Upon recognizing the user input on the sticker list 634, in example 603d, the electronic device 200 may insert a new object 630 into the content based on the user input. The electronic device 200 may provide a guide for editing the new object 630 while inserting the new object 630 into the content. For example, the electronic device 200 may display a first user interface 620b corresponding to the new object 630 in a portion of the first area 610. The portion where the first user interface 620b is displayed may be predetermined on a system of the electronic device 200 and may change in response to a user's settings. For example, in example 603e, the electronic device 200 may insert the new object 630 at the beginning of the content and control it to be displayed for a certain period of time (e.g., about 3 seconds). The insertion position and length of insertion time of the new object 630 are not limited to this, and the electronic device 200 may control the insertion position and length of insertion time of the new object 630 differently depending on a user's settings.

FIG. 6C illustrates a situation where an object is deleted in an electronic device according to various embodiments.

In example 605a, the electronic device 200 may insert a first object 630 and a second object 650 (as depicted in example 605b) in the content. The electronic device 200 may display a first section 620a corresponding to the first object 630 and a second section 622a corresponding to the second object 650 near the first area 610 at corresponding positions in time. In example 605a, an indicator 612 in the first area 610 may be located within the first section 620a. The electronic device 200 may display the first object 630 on a display (e.g., the display 220 of FIG. 2) based on the position of the indicator 612. The electronic device 200 may recognize a user input on the first area 610 and move the position of the indicator 612 based on the recognized user input. In example 605b, the electronic device 200 may move the position of the indicator 612

to the second section 622a based on the user input. In this case, the electronic device 200 may display the second object 650 on the display 220 based on the position of the indicator 612. Thereafter, the electronic device 200 may recognize a user input 640 on the second object 650.

In example 605c, the electronic device 200 may display a second user interface 622b in the first area 610 based on the user input on the second object 650. The electronic device 200 may display the second user interface 622b to guide the user in the editing process of the second object 650. Seeing the second user interface 622b displayed, the user can edit the second object 650. The electronic device 200 may provide a guide for editing the second object. For example, in example 605c, the electronic device 200 may display a delete icon 660 for deleting the second object 650 on or near the second object 650. The electronic device 200 may recognize a user input on the delete icon 660.

Upon recognizing the user input on the delete icon 660, in example 605d, the electronic device 200 may delete the second object 650 from the content based on the recognized user input. In this case, the electronic device 200 may delete both the second section 622a and the second user interface 622b corresponding to the second object 650.

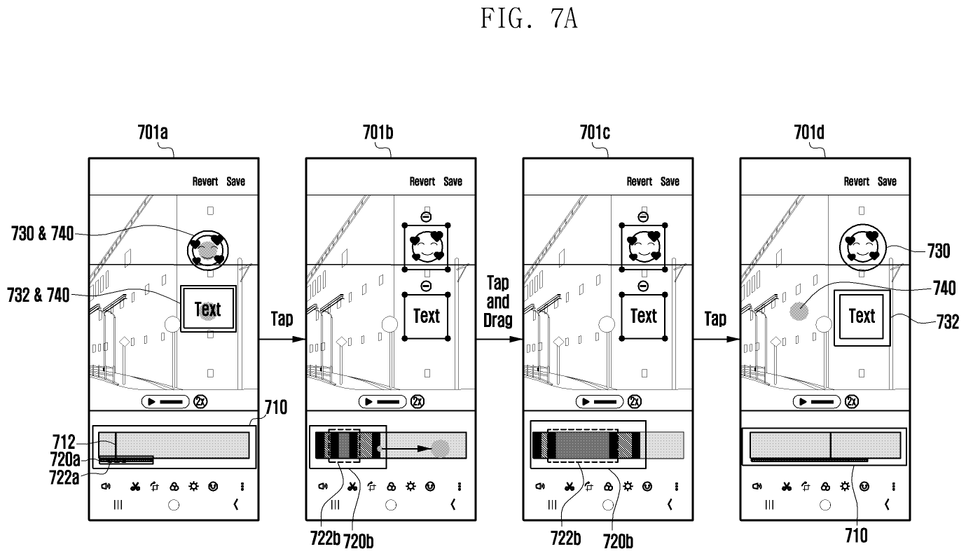

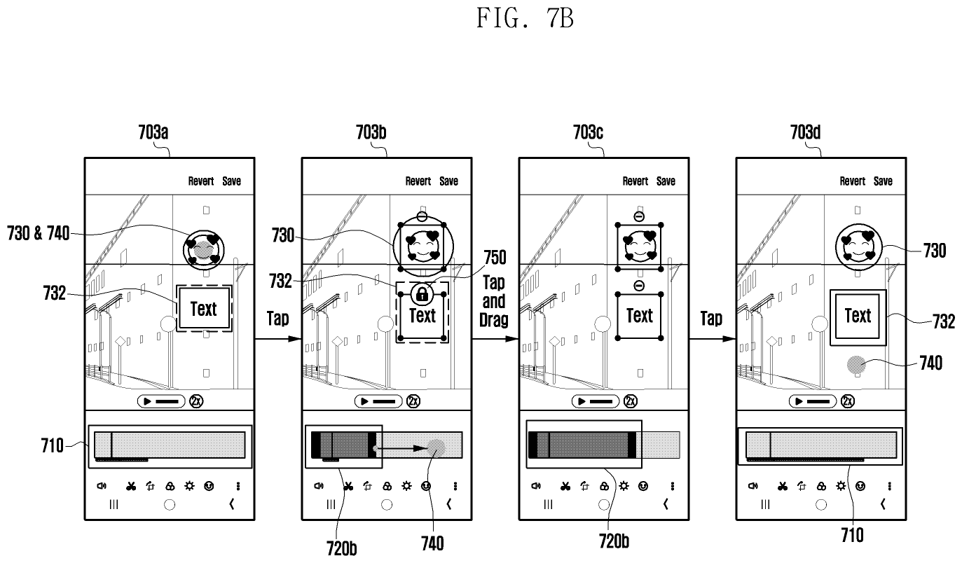

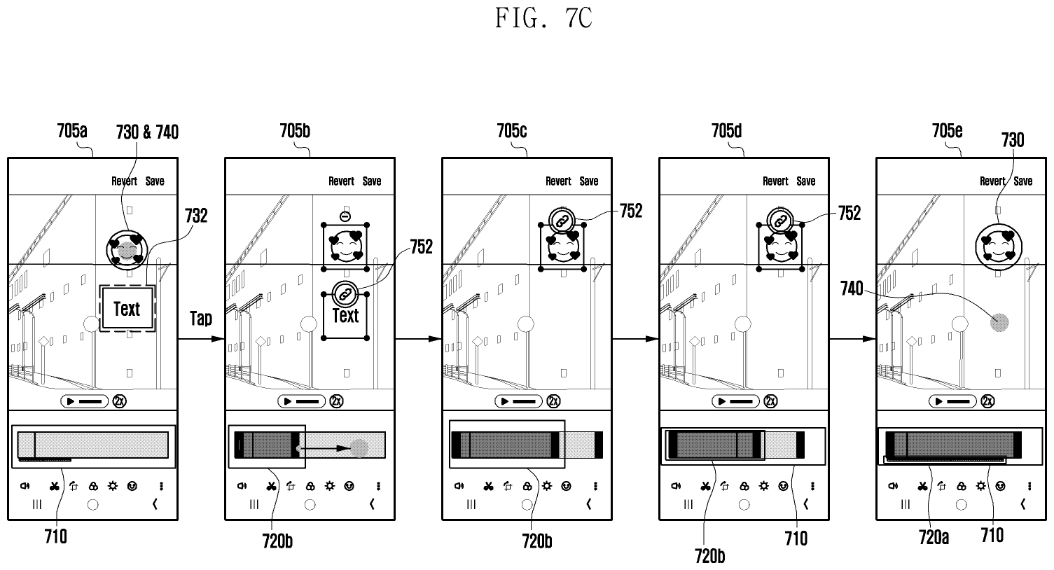

FIG. 7A illustrates a situation where a plurality of objects are selected together and edited simultaneously in an electronic device according to various embodiments.

In example 701a, an electronic device (e.g., the electronic device 200 in FIG. 2) may recognize the position of an indicator 712 in a first area 710. Then, based on the position of the indicator 712, the electronic device 200 may display a first object 730 and/or a second object 732 on a display (e.g., the display 220 in FIG. 2). In example 701a, the electronic device 200 may display a first section 720a corresponding to the first object 730 and a second section 722a corresponding to the second object 732 near the first area 710 at corresponding positions in time. In example 701a, the indicator 712 in the first area 710 may be located within an overlap part between the first section 720a and the second section 722a. In this case, the electronic device 200 may display the first object 730 and the second object 732 together on the display 220 based on the position of the indicator 712. The electronic device 200 may recognize user inputs 740 on the first and second objects 730 and 732. The electronic device 200 may recognize individual user inputs or user inputs simultaneously applied to a plurality of objects. In example 701b, the electronic device 200 may simultaneously display a first user

interface 720b and a second user interface 722b in the first area 710 based on the user inputs 740 on the first and second objects 730 and 732. The electronic device 200 may simultaneously edit the first and second objects 730 and 732 based on the user inputs 740 applied simultaneously on the first and second objects 730 and 732. The electronic device 200 may change the time for which the first object 730 is displayed, based on a user input on the first user interface 720b. In example 701b, the electronic device 200 may recognize the user input on the first user interface 720b and also apply it to the second user interface 722b to edit the first user interface 720b and the second user interface 722b simultaneously.

In example 701c, the electronic device 200 may extend the length of the first user interface 720b to the right based on a drag input applied to the right bar on the first user interface 720b. In this case, the electronic device 200 may apply the same user input to the second user interface 722b to extend the length of the second user interface 722b to the right.

Thereafter, in example 701d, the electronic device 200 may terminate an object editing process based on a user input 740 on an area other than the first object 730, the second object 732, and the first area 710. The electronic device 200 may terminate the editing process of at least one object and display the first section 720a and the second section 722a expanded in response to the expansion of the first user interface 720b and the second user interface 722b.

FIG. 7B illustrates a situation where an editing function for a specific object is locked in an electronic device according to various embodiments.

In example 703a, an electronic device (e.g., the electronic device 200 in FIG. 2) may recognize the position of an indicator 712 in a first area 710. Then, based on the position of the indicator 712, the electronic device 200 may display a first object 730 and/or a second object 732 on the display 220. In example 703a, the electronic device 200 may display a first section 720a corresponding to the first object 730 and a second section 722a corresponding to the second object 732 near the first area 710 at corresponding positions in time. In example 703a, the indicator 712 in the first area 710 may be located within an overlap part between the first section 720a and the second section 722a. In this case, the electronic device 200 may display the first object 730 and the second object 732 together on the display 220 based on the position of the indicator 712. In example 703a, the electronic device 200 may recognize a user input 740 on the first object 730.

In example 703b, the electronic device 200 may display a first user interface 720b in the first area 710 based on the user input 740 on the first object 730. Additionally, the electronic device 200 may execute a lock function for the second object 732 displayed on the display 220 together with the first object 730 and display a lock icon 750 on the second object 732. The user may identify the lock icon 750 displayed on the second object 732 and identify that the editing function of the second object 732 is locked. Alternatively, the electronic device 200 may display the first user interface 720b in the first area 710 based on the user input on the first object 730 and provide a guide regarding whether to lock the second object 732 displayed together with the first object 730. The electronic device 200 may control the editing function of the second object 732 based on a user input regarding whether the editing function of the second object 732 is locked.

In example 703b, the electronic device 200 may recognize a user input on the first user interface 720b. For example, the electronic device 200 may recognize a drag input on the right bar of the first user interface 720b.

Upon recognizing the drag input on the right bar of the first user interface 720b, in example 703c, the electronic device 200 may expand the first user interface 720b based on the recognized user input 740. At this time, unlike example 701c of FIG. 7A, the electronic device may maintain the locked state without expanding the second user interface 722b.

Thereafter, in example 703d, the electronic device 200 may terminate the editing process of the first object 730 based on a user input 740 on an area other than the first object 730, the second object 732, and the first area 710. Identifying that the first user interface 720b disappears, the user can intuitively identify that the editing process of the first object 730 is terminated.

FIG. 7C illustrates a situation where a link function of a plurality of objects is activated in an electronic device according to various embodiments.

In example 705a, the electronic device 200 may simultaneously display the first object 730 and the second object 732 on the display 220. The electronic device 200 may recognize the user input 740 on the first object 730.

In example 705b, the electronic device 200 may display the first user interface 720b based on the user input 740 on the first object 730. Additionally, the electronic device 200 may recognize a user input in the first user interface 720b. The electronic device 200 may activate a link function of the second object 732 displayed on the display 220 in addition to the first object 730 to which the user input 740 has been applied. Upon activating the link function of the second object 732, the electronic device 200 may display a link icon 752 on the second object 732. The user may identify the link icon 752 and intuitively identify that the object link function is activated. Alternatively, the electronic device 200 may provide a guide on whether to activate the link function of the second object 732, based on the user input on the first object 730.

The electronic device 200 may activate the link function of the second object 732 based on a user input. Here, the link function may refer to a function in which the electronic device 200 connects the screen to a predetermined link when the user input 740 is applied to the object. The electronic device 200 may provide a guide for link editing to the user and change the connected link based on the user input. In the case where the link function of the second object 732 is activated, the electronic device 200 may control link information connected to the second object 732 to be modified together even when the user input 740 or a link modification command is applied only to the first object 730. In this case, the user can feel the convenience of being able to edit links connected to multiple objects at once without having to edit them individually. In addition, the electronic device 200 may provide a guide for releasing the link function. The user may individually edit the links of the first and second objects 730 and 732 by disabling the link function.

In example 705c, the electronic device 200 may extend the length of the first user interface 720b based on a user's drag input on the first user interface 720b. In example 705d, the electronic device 200 may recognize a user input in the first area 710. For example, the electronic device 200 may reduce the size of the first area 710 based on a user's drag input applied to the right bar on the first area 710.

According to an embodiment, in order to edit the length of at least one user interface, the electronic device 200 may enlarge a portion of the timeline where a user input is applied, and provide the enlarged portion to the user. The user can edit at least one user interface on a frame-by-frame basis using the enlarged portion. Even when a user input is applied to the first area 710 to edit the length of content, the electronic device 200 may similarly enlarge the portion of the timeline where the user input is applied, and provide the enlarged portion to the user.

Thereafter, in example 705e, the electronic device 200 may recognize a user input 740 on an area other than the first object 730, the second object 732, and the first area 710. Based on this user input, the electronic device 200 may terminate the editing process of content including the first object 730 and the second object 732. Seeing that the first user interface 720b disappears, the user can intuitively identify that the editing process of content is terminated.

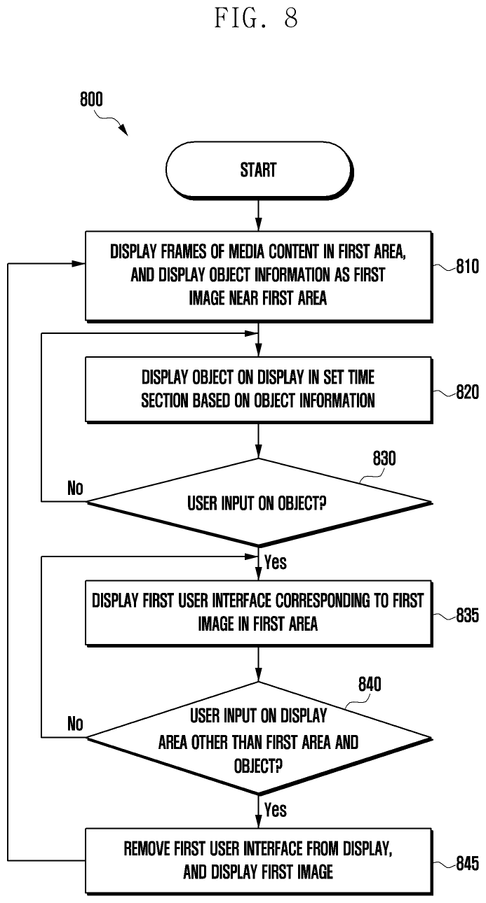

FIG. 8 illustrates a method for editing content in an electronic device according to various embodiments. The operations described through FIG. 8 may be implemented based on instructions that can be stored in a computer recording medium or memory (e.g., the memory 240 in FIG. 2).

The illustrated method 800 can be executed by an electronic device (e.g., the electronic device 200 in FIG. 2) previously described with reference to FIGS. 1 to 7C, and the technical features described above will be omitted below.

The content editing method of the electronic device 200 according to various embodiments may include an operation of displaying at least some frames of media content in a first area (e.g., the first area 710 in FIG. 7) based on the playback time of the media content, an operation of displaying at least one section corresponding to at least one object based on information about the at least one object included in the media content, an operation of determining the at least one section corresponding to the at least one object based on a user input on the at least one object, and an operation of displaying at least one user interface corresponding to the determined at least one section in at least a portion of the first area 710.

In operation 810, the electronic device 200 may reproduce media content (hereinafter referred to as content) and display at least one section including object information near the first area 710. According to an embodiment, the at least one section (e.g., the first section 720a in FIG. 7) corresponding to at least one object may have the form of a relatively thin line compared to the first area 710, and it may be displayed at a location corresponding to the first area in time based on a time zone when at least one corresponding object is inserted in the media content. The first area 710 may refer to a timeline containing frame display information of the content, and it may be displayed in the form of a bar. However, the form of the first area 710 is not limited to this, and it may have any form that can represent the frame display information of the content. Additionally, the first area 710 may be displayed at any location on a display (e.g., display 220 in FIG. 2) and not necessarily be limited to the bottom area of the content.

According to an embodiment, at least one user interface (e.g., the first user interface 720b in FIG. 7) may be displayed in the first area 710, and it may be displayed at a location corresponding to the first area 710 in time based on the time zone when at least one corresponding object is inserted in the media content. The form and role of at least one object and at least one section have been described in FIGS. 4 and 5, and the at least one user interface has been described in FIGS. 6A to 6C.

In operation 820, the electronic device 200 may display an object on the display 220 in a set time section of the first area 710 based on object information. According to an embodiment, the object (e.g., the first object 730 in FIG. 7) may have at least one form of an emoticon, a sticker, a text, a figure, or a drawing, but it may not be limited thereto. Additionally, information about the at least one object may include at least one of the type of the at least one object, the time for which the at least one object is displayed on the content, whether the at least one object is deleted, or link information connected to the at least one object, but it may not be limited to this.

In operation 830, the electronic device 200 may recognize a user input (e.g., user input 740 in FIG. 7) on the at least one object displayed on the display 220. At this time, the user input 740 may include, but is not limited to, a touch input or a drag input. In operation 835, the electronic device 200 may display the first user interface 720b corresponding to the first section 720a in the first area 710 based on the user input 740 on the at least one object 730. The electronic device 200 may recognize a user input 740 on the first user interface 720b. The electronic device 200 may extend or reduce the length of the first user interface 720b based on the user input 740 on the first user interface 720b. Alternatively, the electronic device 200 may delete the first object 730 from the content based on the user input on the first user interface 720b. Embodiments related to content editing of the electronic device 200 based on the user input 740 on the first user interface 720b have been described with reference to FIGS. 6A to 7C.

In operation 840, the electronic device 200 may recognize a user input on an area other than the at least one object 730 and the first area 710. Based on this user input, the electronic device 200 may terminate the content editing process. In operation 845, the electronic device 200 may remove the first user interface 720b from the display 220 based on the user input on an area other than the at least one object 730 and the first area 710, and display the first section 720a. Identifying that the first user interface 720b disappears and the first section 720a is displayed, the user can intuitively identify that the content editing process is terminated.

According to various embodiments, an electronic device includes a display, a memory, and a processor. The processor may be configured to display at least some frames of media content in a first area of the display when reproducing the media content on the display, to display at least one section indicating at least one object included in the media content near the first area of the display, based on at least one object information corresponding to the at least one object, and to display at least one user interface corresponding to the at least one section determined based on a user input on the at least one object in at least a portion of the first area.

According to an embodiment, the at least one section corresponding to the at least one object may have a form of a relatively thin line compared to the first area.

Also, the at least one section may be displayed at a location corresponding to the first area in time based on a time zone when the corresponding at least one object is inserted into the media content.

According to an embodiment, the at least one user interface may be displayed in the first area, and may be displayed at a location corresponding to the first area in time based on a time zone when the corresponding at least one object is inserted into the media content.

According to an embodiment, the processor may be configured to modify object information of the at least one object corresponding to the at least one user interface based on a user input on the at least one user interface.

According to an embodiment, the object information may include at least one of a type of the at least one object, a time for which the at least one object is displayed on the media content, whether the at least one object is deleted, or link information connected to the at least one object.

According to an embodiment, the at least one object may include at least one form of an emoticon, a sticker, a text, or a drawing, and the drawing may include an input using at least one of a figure, an image, an input using a user's body, or an input using a stylus pen.

According to an embodiment, the processor may control to display the corresponding at least one section instead of the at least one user interface based on a user input on the display in an area other than the first area and the second area where the at least one object is located.

According to an embodiment, the at least one object may include a first object and a second object, the at least one section may include a first section corresponding to the first object and a second section corresponding to the second object, the first section may be displayed at a location corresponding to the first area in time based on a time zone when the first object is inserted in the media content, and the second section may be displayed at a location corresponding to the first area in time based on a time zone when the second object is inserted in the media content. The processor may control to display at least one of color, transparency, size, shape, brightness, or saturation differently when the first section and the second section overlap with each other.

According to an embodiment, the processor may determine a color of the at least one section based on a type of the at least one object.

According to an embodiment, the processor may determine a color of the at least one user interface based on a type of the at least one object.

According to an embodiment, the processor may be configured to provide a guide for editing or newly adding the at least one object, to newly include and display at least one object in the media content based on a user input on the guide, and to display at least one user interface corresponding to the at least one newly displayed object in at least a portion of the first area.

According to an embodiment, the processor may be configured to provide a user with a guide for determining a time for which the at least one user interface is displayed, and to, based on a user input on the guide, control at least one user interface corresponding to the at least one newly displayed object to be displayed in the first area for a certain period of time based on a start point of the media content.

According to an embodiment, the processor may be configured to, based on a user input on the at least one object, display a first icon near the at least one object to which the user input is applied, and to, based on a user input on the first icon, control to delete the at least one object from the media content.

According to an embodiment, the processor may be configured to, based on a user input on the at least one object, display a first icon near the at least one object to which the user input is applied, and to, based on a user input on the first icon, provide a guide for editing a link connected to the at least one object.

According to an embodiment, the processor may be configured to, based on a simultaneous user input or sequential user inputs on the first object and the second object, display a first user interface in at least a portion of the first area instead of the first section, and display a second user interface in at least a portion of the first area instead of the second section, and to synchronize the first user interface and the second user interface so as to control modifying the second object information together when modifying the first object information based on a user input on the first user interface, and/or modifying the first object information together when modifying the second object information based on a user input on the second user interface.

According to an embodiment, the processor may be configured to display a first icon near the first object and display a second icon near the second object, to, based on a user input on the first icon, maintain the first object and a first user interface corresponding to the first object in a locked state, and to, based on a user input on the second icon, maintain the second object and a second user interface corresponding to the second object in a locked state. The locked state may include a state that does not respond to a user input.

According to an embodiment, the processor may be configured to release the locked state of the first object and the first user interface based on a user input on the first icon in the locked state of the first object and the first user interface, and to release the locked state of the second object and the second user interface based on a user input on the second icon in the locked state of the second object and the second user interface.

According to various embodiments, a content editing method of an electronic device may include displaying at least some frames of media content in a first area of a display, based on a playback time of the media content; displaying at least one section indicating at least one object included in the media content near the first area of the display, based on at least one object information corresponding to the at least one object; and displaying at least one user interface corresponding to the at least one section determined based on a user input on the at least one object in at least a portion of the first area.

According to an embodiment, the at least one section corresponding to the at least one object may have a form of a relatively thin line compared to the first area, and may be displayed at a location corresponding to the first area in time based on a time zone when the corresponding at least one object is inserted into the media content, and the at least one user interface may be displayed in the first area, and may be displayed at a location corresponding to the first area in time based on a time zone when the corresponding at least one object is inserted into the media content.

According to an embodiment, the method may further include modifying object information of the at least one object corresponding to the at least one user interface based on a user input on the at least one user interface, wherein the object information may include at least one of a type of the at least one object, a time for which the at least one object is displayed on the media content, whether the at least one object is deleted, or link information connected to the at least one object.

According to an embodiment, the method may further include providing a guide for editing or newly adding the at least one object, including and newly displaying at least one object in the media content based on a user input on the guide, and displaying at least one user interface corresponding to the at least one newly displayed object in at least a portion of the first area.

The embodiments disclosed in the specification and drawings are merely presented as specific examples to easily explain the technical contents according to the embodiments and to aid understanding of the embodiments and are not intended to limit the scope of the embodiments. Therefore, the scope of various embodiments of the disclosure should be interpreted as including all changes or modifications derived based on the technical idea of the embodiments in addition to the embodiments disclosed herein.

What is claimed is:

1. An electronic device comprising:
a display;
a memory; and
a processor operatively connected to the display and the memory, the processor configured to:
display a preview of media content in a first area of the display,
display at least one frame corresponding to the media content in a second area of the display,
select at least one object contained within the first area,
determine a frame segment corresponding to the object in response to the selection, and
display the frame segment visually distinct from other segments.

2. The electronic device of claim 1, wherein the at least one section corresponding to the at least one object has a form of a relatively thin line compared to the first area, and is displayed at a location corresponding to the first area in time based on a time zone when the corresponding at least one object is inserted into the media content.

3. The electronic device of claim 1, wherein the at least one user interface is displayed in the first area, and is displayed at a location corresponding to the first area in time based on a time zone when the corresponding at least one object is inserted into the media content.

4. The electronic device of claim 1, wherein the processor is configured to modify object information of the at least one object corresponding to the at least one user interface based on a user input on the at least one user interface.

5. The electronic device of claim 1, wherein the object information includes at least one of a type of the at least one object, a time for which the at least one object is displayed on the media content, whether the at least one object is deleted, or link information connected to the at least one object.

6. The electronic device of claim 1, wherein the at least one object includes at least one form of an emoticon, a sticker, a text, or a drawing, and
the drawing includes an input using at least one of a figure, an image, an input using a user's body, or an input using a stylus pen.

7. The electronic device of claim 1, wherein the processor controls to display the corresponding at least one section instead of the at least one user interface based on a user input on the display in an area other than the first area and the second area where the at least one object is located.

8. The electronic device of claim 2, wherein the at least one object includes a first object and a second object,
the at least one section includes a first section corresponding to the first object and a second section corresponding to the second object,
the first section is displayed at a location corresponding to the first area in time based on a time zone when the first object is inserted in the media content,
the second section is displayed at a location corresponding to the first area in time based on a time zone when the second object is inserted in the media content, and
the processor controls to display at least one of color, transparency, size, shape, brightness, or saturation differently when the first section and the second section overlap with each other.

9. The electronic device of claim 1, wherein the processor determines a color of the at least one section or determines a color of the at least one user interface based on a type of the at least one object.

10. The electronic device of claim 1, wherein the processor is configured to:
provide a guide for editing or newly adding the at least one object,
newly include and display at least one object in the media content based on a user input on the guide, and
display at least one user interface corresponding to the at least one newly displayed object in at least a portion of the first area.

11. The electronic device of claim 1, wherein the processor is configured to:
provide a user with a guide for determining a time for which the at least one user interface is displayed, and
based on a user input on the guide, control at least one user interface corresponding to the at least one newly displayed object to be displayed in the first area for a certain period of time based on a start point of the media content.

12. The electronic device of claim 1, wherein the processor is configured to:
based on a user input on the at least one object, display a first icon near the at least one object to which the user input is applied, and
based on a user input on the first icon, control to delete the at least one object from the media content.

13. The electronic device of claim 1, wherein the processor is configured to:
based on a user input on the at least one object, display a first icon near the at least one object to which the user input is applied, and
based on a user input on the first icon, provide a guide for editing a link connected to the at least one object.

14. The electronic device of claim 8, wherein the processor is configured to:
based on a simultaneous user input or sequential user inputs on the first object and the second object, display a first user interface in at least a portion of the first area instead of the first section, and display a second user interface in at least a portion of the first area instead of the second section, and
synchronize the first user interface and the second user interface so as to control modifying the second object information together when modifying the first object information based on a user input on the first user interface, and/or modifying the first object information together when modifying the second object information based on a user input on the second user interface.

15. The electronic device of claim 8, wherein the processor is configured to:
display a first icon near the first object and display a second icon near the second object,
based on a user input on the first icon, maintain the first object and a first user interface corresponding to the first object in a locked state, and
based on a user input on the second icon, maintain the second object and a second user interface corresponding to the second object in a locked state, and
wherein the locked state includes a state that does not respond to a user input.

16. The electronic device of claim 15, wherein the processor is configured to:
release the locked state of the first object and the first user interface based on a user input on the first icon in the locked state of the first object and the first user interface, and
release the locked state of the second object and the second user interface based on a user input on the second icon in the locked state of the second object and the second user interface.

17. A content editing method of an electronic device, the method comprising:
displaying a preview of media content in a first area of a display,
displaying at least one frame corresponding to the media content in a second area of the display,
selecting at least one object contained within the first area,
determining a frame segment corresponding to the object in response to the selection, and
displaying the frame segment visually distinct from other segments.

18. The method of claim 17, wherein the at least one section corresponding to the at least one object has a form of a relatively thin line compared to the first area, and is displayed at a location corresponding to the first area in time based on a time zone when the corresponding at least one object is inserted into the media content, and
the at least one user interface is displayed in the first area, and is displayed at a location corresponding to the first area in time based on a time zone when the corresponding at least one object is inserted into the media content.

19. The method of claim 17, further comprising:
modifying object information of the at least one object corresponding to the at least one user interface based on a user input on the at least one user interface,
wherein the object information includes at least one of a type of the at least one object, a time for which the at least one object is displayed on the media content, whether the at least one object is deleted, or link information connected to the at least one object.

20. The method of claim 17, further comprising:
providing a guide for editing or newly adding the at least one object;
including and newly displaying at least one object in the media content based on a user input on the guide; and
displaying at least one user interface corresponding to the at least one newly displayed object in at least a portion of the first area.
